(19) United States
(12) Patent Application Publication
(10) Pub. No.: US 2016/0064720 A1
(43) Pub. Date: Mar. 3, 2016

(54) SECONDARY-BATTERY COLLECTOR TERMINAL AND MANUFACTURING METHOD OF SECONDARY BATTERY

(71) Applicant: TOYOTA JIDOSHA KABUSHIKI KAISHA, Toyota-shi (JP)

(72) Inventors: Hiroya UMEYAMA, Okazaki-shi (JP); Kiyomi KOZUKI, Osaka (JP)

(73) Assignee: TOYOTA JIDOSHA KABUSHIKI KAISHA, Toyota-shi (JP)

(21) Appl. No.: 14/837,631

(22) Filed: Aug. 27, 2015

(30) Foreign Application Priority Data
Aug. 29, 2014 (JP) 2014-175809

(51) Int. Cl. H01M 2/22; B23K 26/24; H01M 2/30

(52) U.S. Cl. CPC H01M 2/22; H01M 2/30; B23K 26/24

(57) ABSTRACT

A secondary-battery collector terminal to be welded to an edge portion of an electrode body includes: a flat portion having a front surface and a back surface; and a welding projection portion having a linearly extending shape, the welding projection portion being formed by projecting a part of the flat portion. The welding projection portion has a shape projecting relative to the flat portion so that a front-surface side thereof exhibits a projecting shape and a back-surface side thereof exhibits a recessed shape. When a sectional shape of the welding projection portion in a direction perpendicular to an extending direction thereof is viewed, a surface shape of that first region of the welding projection portion which is placed on the front-surface is curved, and a surface shape of that second region of the welding projection portion which is placed on a back-surface side relative to the first region is flat.

### INCORPORATION BY REFERENCE

The disclosure of Japanese Patent Application No. 2014-175809 filed on Aug. 29, 2014 including the specification, drawings and abstract is incorporated herein by reference in its entirety.

### BACKGROUND OF THE INVENTION

1. Field of the Invention

The present invention relates to a secondary-battery collector terminal to be provided in a secondary battery, and a manufacturing method of a secondary battery.

2. Description of Related Art

An electrode body used for a secondary battery is manufactured such that a separator is provided between a positive electrode core and a negative electrode core, and they are wound in a spiral shape. As described in Japanese Patent Application Publication No. 2007-250442 (JP 2007-250442 A), there has been known a technique to weld a collector terminal to an edge portion (a part where a plurality of core portions is laminated) of an electrode body. The edge portion of the electrode body is a part configured as follows.

That is, an unapplied portion (a positive-electrode-core exposed portion) to which a positive-electrode active material is not applied is formed in a positive electrode core, and after winding, the unapplied portion projects from an end of a separator so as to constitute an edge portion on a positive electrode side. Similarly, an unapplied portion (a negative-electrode-core exposed portion) to which a negative-electrode active material is not applied is formed in a negative electrode core, and after the winding, the unapplied portion projects from an end of the separator so as to constitute an edge portion on a negative electrode side. Respective collector terminals for a positive electrode and for a negative electrode are welded to these edge portions on the positive electrode side and on the negative electrode side.

The collector terminal (also referred to as a current collector plate) described in JP 2007-250442 A includes a plurality of projection portions. A sectional shape of the projection portion is a trapezoidal shape or a semicircular shape. After a bottom part of the projection portion (that surface of the projection portion which exhibits a projecting shape) is pressed against the edge portion of the electrode body, laser for welding is applied thereto from a backside of the projection portion. The bottom part of the projection portion is joined to the edge portion of the electrode body by welding. The collector terminal is electrically connected to the edge portion of the electrode body, so that the collector terminal can collect currents.

As described in JP 2007-250442 A, it is assumed that the sectional shape of the projection portion to be formed in the collector terminal is a trapezoidal shape. In this case, since a backside surface of the projection portion (that surface of the projection portion which exhibits a recessed shape) is flat, it is possible to increase a tolerance limit of misalignment of a high energy beam such as laser to an irradiation position. However, in a case where the sectional shape of the projection portion is a trapezoidal shape, that surface of the projection portion which projects (that surface of the projection portion which exhibits a projecting shape) is also flat. Accordingly, at the time when the projection portion is pressed against the edge portion of the electrode body, the edge portion of the electrode body is hard to be bent uniformly (hard to fall), which may easily cause local bending, buckling, or the like in the edge portion of the electrode body. When such local bending or buckling occurs, an unnecessary gap is formed between the edge portion of the electrode body and the collector terminal, so that they unstably make contact with each other. The formation of such an unnecessary gap may cause variations in heat capacity at the time of application of laser or the like, destruction of the edge portion of the collector by firing, insufficient melting, and the like. Accordingly, in a case where the sectional shape of the projection portion to be formed in the collector terminal is a trapezoidal shape, it is difficult to join the collector terminal to the edge portion of the electrode body with sufficient welding strength.

In the meantime, as illustrated in FIG. 14 of JP 2007-250442 A, it is assumed that the sectional shape of the projection portion to be formed in the collector terminal is a simple semicircular shape. In this case, since that surface of the projection portion which projects (that surface of the projection portion which exhibits a projecting shape) is curved, at the time when the projection portion is pressed against the edge portion of the electrode body, the edge portion of the electrode body is easily bent uniformly. Accordingly, local bending, buckling, or the like does not occur in the edge portion of the electrode body so often in comparison with a case where the sectional shape is a trapezoidal shape. However, in a case where the sectional shape of the projection portion is a simple semicircular shape, at the time when a high energy beam such as laser is applied to the projection portion, heat is hard to dissipate because that surface of the projection portion which exhibits a recessed shape is curved, thereby resulting in that a temperature of a tip end of the projection portion easily increases to a necessary temperature or more. In a case where a laser beam penetrates through the collector terminal (the projection portions) due to the increase in the temperature, the separator melts, which may presumably cause a short circuit (a yield loss) between the positive electrode core and the negative electrode core.

### SUMMARY OF THE INVENTION

The present invention provides a secondary-battery collector terminal which can restrain a temperature of a tip end of a projection portion from increasing to a necessary temperature or more at the time of welding and which can be joined to an edge portion of an electrode body with sufficient welding strength, and a manufacturing method of a secondary battery.

A secondary-battery collector terminal according to an aspect of the present invention is a secondary-battery collector terminal to be welded to an edge portion of an electrode body, and includes: a flat portion having a front surface and a back surface; and a welding projection portion having a linearly extending shape, the welding projection portion being formed by projecting a part of the flat portion, wherein the welding projection portion has a shape projecting relative to the flat portion such that a front-surface side thereof exhibits a projecting shape and a back-surface side thereof exhibits a recessed shape, and when a sectional shape of the welding projection portion in a direction perpendicular to an extending direction thereof is viewed, a surface shape of that first region of the welding projection portion which is placed on the front-surface is curved, and a surface shape of that second region of the welding projection portion which is placed on a back-surface side relative to the first region is flat.

A secondary-battery collector terminal according to another aspect of the present invention is a secondary-battery collector terminal to be welded to an edge portion of an electrode body, and includes: a flat portion having a front surface and a back surface; and a welding projection portion having a linearly extending shape, the welding projection portion being formed by projecting a part of the flat portion, wherein the welding projection portion has a shape projecting relative to the flat portion so that a front-surface side thereof exhibits a projecting shape and a back-surface side thereof exhibits a recessed shape, and when a sectional shape of the welding projection portion in a direction perpendicular to an extending direction thereof is viewed, a surface shape of that first region of the welding projection portion which is placed on the front-surface is curved with a first curvature radius, and a surface shape of that second region of the welding projection portion which is placed on a back-surface side relative to the first region is curved with a second curvature radius larger than the first curvature radius.

In the above aspect, in a case where a dimension in a direction perpendicular to a thickness direction of the flat portion is defined as a width when the sectional shape of the welding projection portion in the direction perpendicular to the extending direction thereof is viewed, the first region has a width of 3 mm or less, the second region has a width of 0.5 mm or more, and in a direction parallel to the thickness direction of the flat portion, a projection height of a tip end of the welding projection portion from the flat portion is 0.5 mm or more.

A manufacturing method of a secondary battery according to further another aspect of the present invention includes: preparing the above secondary-battery collector terminal; and applying laser for welding to the second region in a state where the first region of the secondary-battery collector terminal abuts with the edge portion of the electrode body.

According to the above configuration, it is possible to provide a secondary-battery collector terminal which can restrain a temperature of a tip end of a projection portion from increasing to a necessary temperature or more at the time of welding and which can be joined to an edge portion of an electrode body with sufficient welding strength, and a manufacturing method of a secondary battery.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view illustrating a secondary battery in Embodiment 1 of the present invention;

FIG. 2 is a perspective view illustrating, in an exploded manner, a configuration around a positive collector terminal to be used in the secondary battery in Embodiment 1 of the present invention;

FIG. 3 is a view illustrating the positive collector terminal when viewed from a direction indicated by an arrow III in FIG. 2;

FIG. 4 is a sectional view taken along an a IV-IV in FIG. 3;

FIG. 5 is a flow diagram illustrating a manufacturing method of a secondary battery in Embodiment 1 of the present invention;

FIG. 6 is a front view illustrating a positive collector terminal (before welding) to be prepared in the manufacturing method of a secondary battery in Embodiment 1 of the present invention;

FIG. 7 is a sectional view taken along an arrow VII-VII in FIG. 6;

FIG. 8 is a perspective view illustrating a state where a welding projection portion of the positive collector terminal to be used in the secondary battery in Embodiment 1 of the present invention is pressed against an edge portion of a positive-electrode-core exposed portion;

FIG. 9 is a view illustrating the positive collector terminal and so on when viewed from a direction indicated by an arrow IX in FIG. 8;

FIG. 10 is a view illustrating the positive collector terminal and so on when viewed from a direction indicated by an arrow X in FIG. 8;

FIG. 11 is a view illustrating the edge portion of the positive-electrode-core exposed portion when viewed from a direction indicated by an arrow XI in FIG. 8;

FIG. 12 is a sectional view illustrating a state where the welding projection portion of the positive collector terminal to be used in the secondary battery in Embodiment 1 of the present invention is welded to the edge portion of the positive-electrode-core exposed portion;

FIG. 13 is a picture illustrating a state before the welding projection portion of the positive collector terminal is welded to the edge portion (a bent portion) of the electrode body, in terms of Embodiment 1 of the present invention;

FIG. 14 is a picture illustrating a state after the welding projection portion of the positive collector terminal is welded to the edge portion (the bent portion) of the electrode body, in terms of Embodiment 1 of the present invention;

FIG. 15 is a sectional view illustrating a state where a positive collector terminal in Comparative Example 1 is welded to an edge portion of an electrode body (a positive-electrode-core exposed portion);

FIG. 16 is a sectional view illustrating a state where a positive collector terminal in Comparative Example 2 is welded to an edge portion of an electrode body (a positive-electrode-core exposed portion);

FIG. 17 is a sectional view illustrating a state where a positive collector terminal in Comparative Example 3 is welded to an edge portion of an electrode body (a positive-electrode-core exposed portion);

FIG. 18 is a sectional view illustrating a positive collector terminal (before welding) to be prepared in a manufacturing method of a secondary battery in a modification of Embodiment 1 of the present invention;

FIG. 19 is a front view illustrating a positive collector terminal (before welding) to be prepared in a manufacturing method of a secondary battery in Embodiment 2 of the present invention;

FIG. 20 is a front view illustrating a positive collector terminal (before welding) to be prepared in a manufacturing method of a secondary battery in Embodiment 3 of the present invention;

FIG. 21 is a front view illustrating a positive collector terminal (before welding) to be prepared in a manufacturing method of a secondary battery in Embodiment 4 of the present invention;

FIG. 22 is a front view illustrating a positive collector terminal (before welding) to be prepared in a manufacturing method of a secondary battery in Embodiment 5 of the present invention;

FIG. 23 is a front view illustrating a positive collector terminal (before welding) to be prepared in a manufacturing method of a secondary battery in Embodiment 6 of the present invention;

FIG. 24 is a front view illustrating a positive collector terminal (before welding) to be prepared in a manufacturing method of a secondary battery in Embodiment 7 of the present invention;

FIG. 25 is a front view illustrating a positive collector terminal (before welding) to be prepared in a manufacturing method of a secondary battery in Embodiment 8 of the present invention;

FIG. 26 is a front view illustrating a positive collector terminal (before welding) to be prepared in a manufacturing method of a secondary battery in Embodiment 9 of the present invention; and

FIG. 27 is a front view illustrating a positive collector terminal (before welding) to be prepared in a manufacturing method of a secondary battery in Embodiment 10 of the present invention.

### DETAILED DESCRIPTION OF EMBODIMENTS

A secondary-battery collector terminal and a manufacturing method of a secondary battery according to Embodiments will be described below with reference to the drawings. The same reference numeral is assigned to the same component and its equivalent component, and a redundant description may not be repeated.

### Embodiment 1

### (Secondary Battery 100)

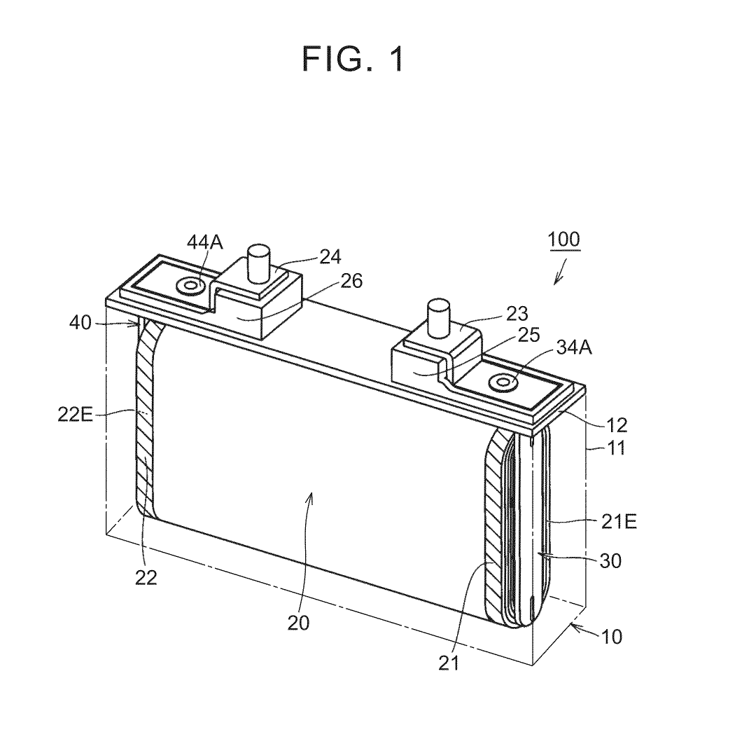

FIG. 1 is a perspective view illustrating a secondary battery 100. The secondary battery 100 includes an outer packaging can 10, an electrode body 20, a positive collector terminal 30 (a secondary-battery collector terminal), a negative collector terminal 40 (a secondary-battery collector terminal), and external terminals 23, 24.

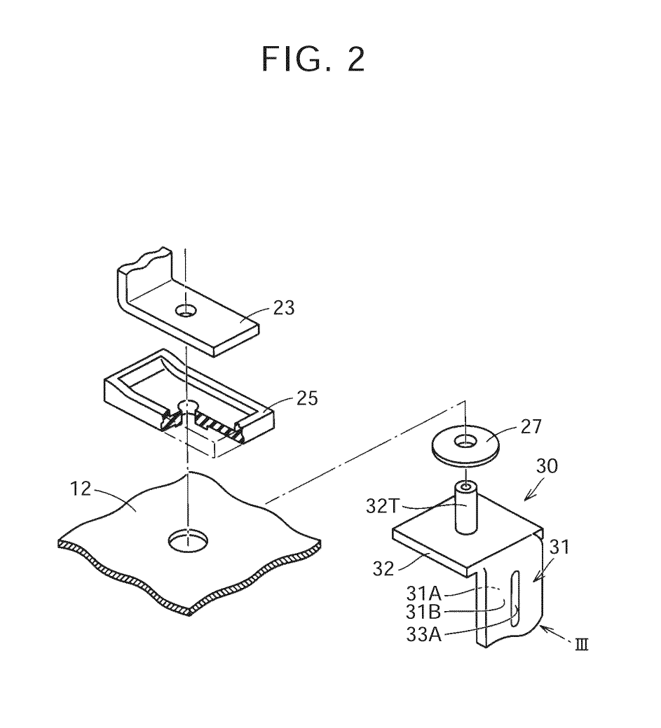

The outer packaging can 10 includes a receptacle portion 11 and a sealing plate 12. The receptacle portion 11 has a bottomed squarely cylindrical shape and accommodates the electrode body 20 therein. The sealing plate 12 is welded to an upper end of the receptacle portion 11 so as to close an opening of the receptacle portion 11. A nonaqueous electrolyte is poured into the receptacle portion 11 sealed by the sealing plate 12. The external terminals 23, 24 are configured to take out electric power generated by the electrode body 20 and to supply external electric power to the electrode body 20, and are attached to the sealing plate 12 via insulators 25, 26, respectively (see FIG. 2).

The electrode body 20 is manufactured by winding a positive electrode core and a negative electrode core via a separator (a porous insulating layer). A positive-electrode-core exposed portion 21 (an unapplied portion) to which a positive-electrode active material is not applied is formed in the positive electrode core. A part of the positive-electrode-core exposed portion 21 is exposed from an end of the separator even after the winding. Similarly, a negative-electrode-core exposed portion 22 (an unapplied portion) to which a negative-electrode active material is not applied is formed in the negative electrode core. A part of the negative-electrode-core exposed portion 22 is exposed from an end of the separator even after the winding.

An end surface of the positive-electrode-core exposed portion 21 is wound in a spiral shape and gathered, so that an edge portion 21E is formed in an edge (an end surface) on one side of the electrode body 20 in its winding-axis direction. The edge portion 21E is placed generally on a single plane, and the plane virtually formed of the edge portion 21E is generally perpendicular to a winding axis of the electrode body 20. The positive collector terminal 30 is joined to the edge portion 21E by welding.

An end surface of the negative-electrode-core exposed portion 22 is wound in a spiral shape and gathered, so that an edge portion 22E is formed in an edge (an end surface) on the other side of the electrode body 20 in the winding-axis direction. The edge portion 22E is placed generally on a single plane, and the plane virtually formed of the edge portion 22E is generally perpendicular to the winding axis of the electrode body 20. The negative collector terminal 40 is joined to the edge portion 22E by welding.

### (Positive Collector Terminal 30 and Negative Collector Terminal 40)

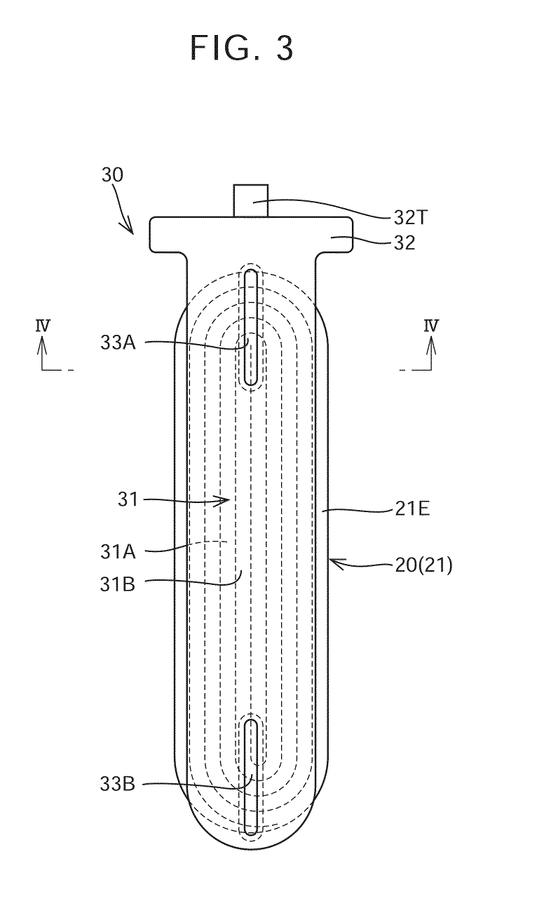

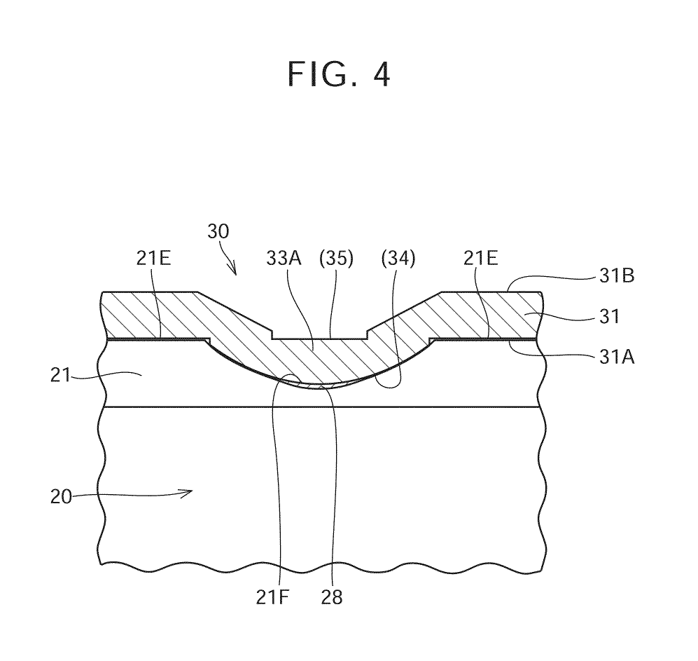

FIG. 2 is a perspective view illustrating, in an exploded manner, a configuration around the positive collector terminal 30 to be used in the secondary battery 100. FIG. 3 is a view illustrating a configuration of the positive collector terminal 30 when viewed from a direction indicated by an arrow III in FIG. 2. For convenience of illustration, the electrode body 20 is not illustrated in FIG. 2, but the electrode body 20 is illustrated in FIG. 3. FIG. 4 is a sectional view taken along an arrow IV-IV in FIG. 3. Referring now to FIGS. 2 to 4, the following describes the positive collector terminal 30 in detail. The positive collector terminal 30 and the negative collector terminal 40 have the same configuration, so the following description deals with the positive collector terminal 30, and a description about the negative collector terminal 40 may not be repeated.

As illustrated in FIGS. 2 to 4, the positive collector terminal 30 includes a flat portion 31 having a flat shape, an extending portion 32 (FIGS. 2, 3) extending perpendicularly to the flat portion 31, and a standing portion 32T (FIGS. 2, 3) provided on the extending portion 32 in a standing manner. The flat portion 31 includes a front surface 31A and a back surface 31B placed on an opposite side to the front surface 31A. By projecting part of the flat portion 31 by use of machining technique such as press working, welding projection portions 33A, 33B are formed in the flat portion 31. The welding projection portions 33A, 33B have a shape extending linearly (see FIG. 3) and also have a shape projecting in a projecting shape toward a front-surface-31A side from a back-surface-31B side (see FIG. 4).

As illustrated in FIG. 2, the sealing plate 12 has a through hole corresponding to the standing portion 32T. The standing portion 32T of the positive collector terminal 30 is passed through the through hole via an insulator 27 (FIG. 2). The insulator 25 and the external terminal 23 also have through holes corresponding to the standing portion 32T. The standing portion 32T is passed through the through hole of the insulator 25 and the through hole of the external terminal 23 in this order. A part of the standing portion 32T (a part of the positive collector terminal 30) extends outside the outer packaging can 10 (FIG. 1) so as to be caulked on the external terminal 23, thereby forming a circular plate shape 34A (see FIG. 1). A negative electrode side also has this configuration, and a part of the negative collector terminal 40 (FIG. 1) extends outside the outer packaging can 10 so as to be caulked on the external terminal 24, thereby forming a circular plate shape 44A.

Referring now to FIGS. 3 and 4, the welding projection portions 33A, 33B have a shape projecting relative to the flat portion 31 so that a front-surface-31A side (a front side) exhibits a projecting shape and a back-surface-31B side (a back side) exhibits a recessed shape (see FIG. 4). As illustrated in FIG. 4, when a sectional shape of the welding projection portion 33A in a direction perpendicular to an extending direction thereof is viewed, a surface of that part of the welding projection portion 33A which is placed on the front-surface-31A side has a generally curved shape. This part corresponds to a first region 34 (described later) in a state before welding.

In the meantime, a surface of that part of the welding projection portion 33A which is placed on the back-surface-31B side has a generally flat shape. This part corresponds to a second region 35 (described later) in a state before welding. In the state before welding, the first region 34 has a curved shape and the second region 35 has a flat shape (described later). These regions are deformed by performing a welding step, so the first region 34 may not exhibit a complete curved shape. Similarly, the second region 35 may not exhibit a complete flat shape.

### (Manufacturing Method of Secondary Battery 100)

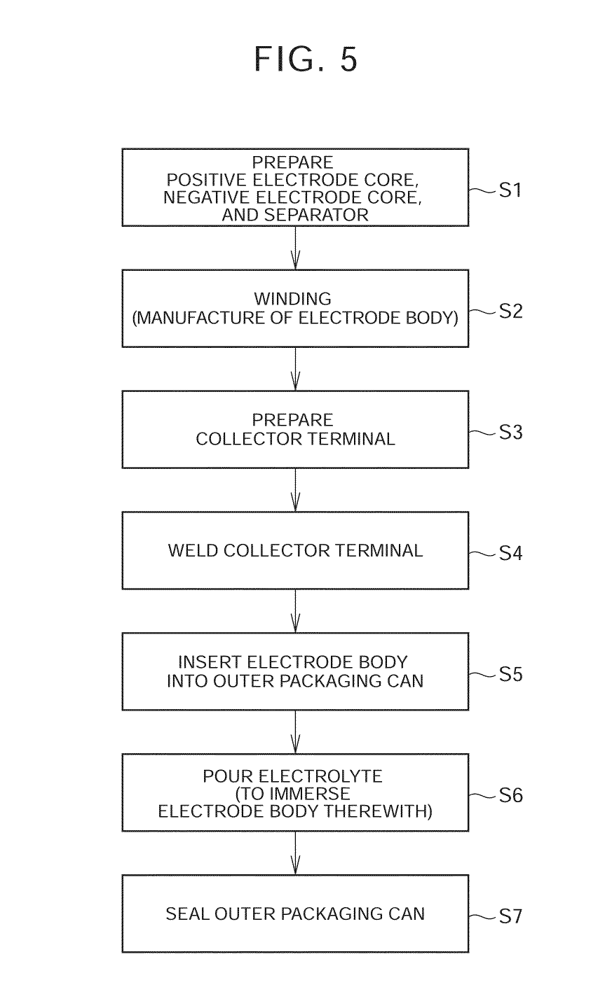

Referring now to FIGS. 5 to 12, the following describes a manufacturing method of a secondary battery 100. Herein, a configuration of the positive collector terminal 30 (a secondary-battery collector terminal) before welding is performed is also described.

FIG. 5 is a flow diagram illustrating the manufacturing method of the secondary battery 100. As illustrated in FIG. 5, first, a positive electrode core, a negative electrode core, and a separator are prepared (step S1). More specifically, a metal foil made of aluminum or aluminum alloy is prepared, and a positive-electrode active material is formed on either surface of the metal foil except an end part thereof. By performing predetermined processing such as drying, rolling, and cutting, a positive electrode core having a positive-electrode-core exposed portion 21 (see FIG. 1) is formed. Similarly, a metal foil made of copper is prepared, and a negative-electrode active material is formed on either surface of the metal foil except an end part thereof. By performing predetermined processing such as drying, rolling, and cutting, a negative electrode core having a negative-electrode-core exposed portion 22 (see FIG. 1) is formed.

Then, an electrode body 20 is formed (step S2). In a state where the positive electrode core and the negative electrode core are displaced from each other so that the positive-electrode-core exposed portion 21 of the positive electrode core and the negative-electrode-core exposed portion 22 of the negative electrode core do not overlap with their respectively opposed electrode active materials, the positive electrode core and the negative electrode core are wound via a porous separator made of polyethylene. Hereby, the electrode body 20 having a flat shape and including, on both ends thereof, the positive-electrode-core exposed portion 21 (an edge portion 21E) made of a plurality of aluminum foils and the negative-electrode-core exposed portion 22 (an edge portion 22E) made of a plurality of copper foils can be obtained (see FIG. 1).

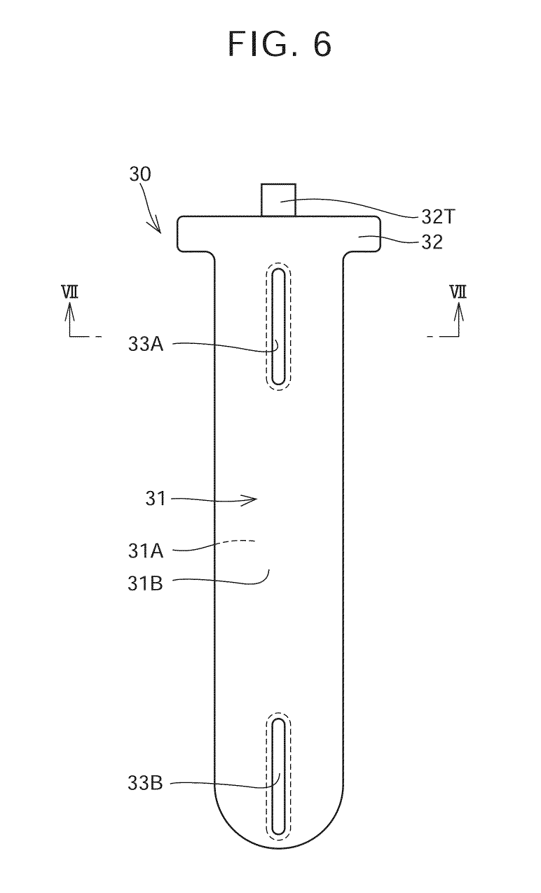

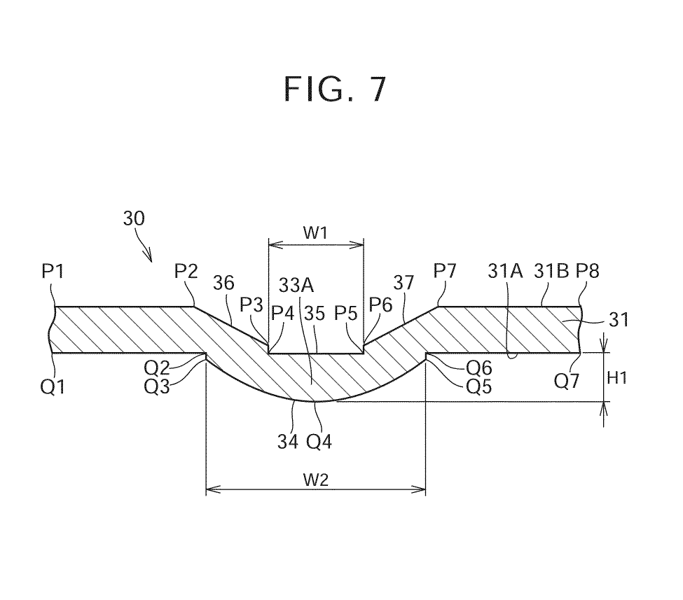

Then, a positive collector terminal 30 and a negative collector terminal 40 are prepared (step S3). The following describes the positive collector terminal 30 and the negative collector terminal 40 to be prepared herein, with reference to FIGS. 6 and 7. Since the positive collector terminal 30 and the negative collector terminal 40 have the same configuration, a description about the negative collector terminal 40 is not repeated.

### (Positive Collector Terminal 30)

FIG. 6 is a front view illustrating the positive collector terminal 30 (before welding). FIG. 7 is a sectional view taken along an arrow VII-VII in FIG. 6. As illustrated in FIGS. 6 and 7, a flat portion 31 of the positive collector terminal 30 has a front surface 31A and a back surface 31B placed on an opposite side to the front surface 31A. By projecting part of the flat portion 31 by use of machining technique such as press working, welding projection portions 33A, 33B are formed in the flat portion 31.

Similarly to the above state after welding, the welding projection portions 33A, 33B have a shape extending linearly (see FIG. 6) and also have a shape projecting in a projecting shape toward a front-surface-31A side from a back-surface-31B side (see FIG. 7). The welding projection portions 33A, 33B have a shape projecting relative to the flat portion 31 so that the front-surface-31A side (a front side) exhibits a projecting shape and the back-surface-31B side (a back side) exhibits a recessed shape (see FIG. 7).

As illustrated in FIG. 7, when a sectional shape of the welding projection portion 33A in a direction perpendicular to an extending direction thereof is viewed, the welding projection portion 33A has a first region 34 on the front-surface-31A side and a second region 35 on the back-surface-31B side. The second region 35 is placed on a back-surface-31B side relative to the first region 34 in the welding projection portion 33A. Here, a surface shape of the first region 34 is curved, and a surface shape of the second region 35 is flat.

More specifically, the front surface 31A of that part of the positive collector terminal 30 which forms the flat portion 31 (that is, a region between points Q1 and Q2 and a region between points Q7 and Q6 in FIG. 7) has a flat shape. These regions are continuous with the first region 34 via stepped portions (a part between points Q2 and Q3 and a part between Q6 and Q5). That is, in the present embodiment, the first region 34 is a part placed between the points Q3 and Q5 in FIG. 7, and a point Q4 is placed at a tip end of the first region 34 in a projection direction. As described above, the surface shape of the first region 34 (a surface shape of the part placed between the points Q3 and Q5) is curved.

The back surface 31B of that part of the positive collector terminal 30 which forms the flat portion 31 (that is, a region between points P1 and P2 and a region between points P8 and P7 in FIG. 7) has a flat shape. An inclined surface 36 is formed between points P2 and P3, and an inclined surface 37 is formed between points P7 and P6. The inclined surfaces 36, 37 have a shape inclined toward a side where the second region 35 is placed. The inclined surfaces 36, 37 are continuous with the second region 35 via stepped portions (a part between points P3 and P4 and a part between P6 and P5). That is, in the present embodiment, the second region 35 is a part placed between the points P4 and P5 in FIG. 7. As described above, the surface shape of the second region 35 (a surface shape of the part placed between the points P4 and P5) is flat.

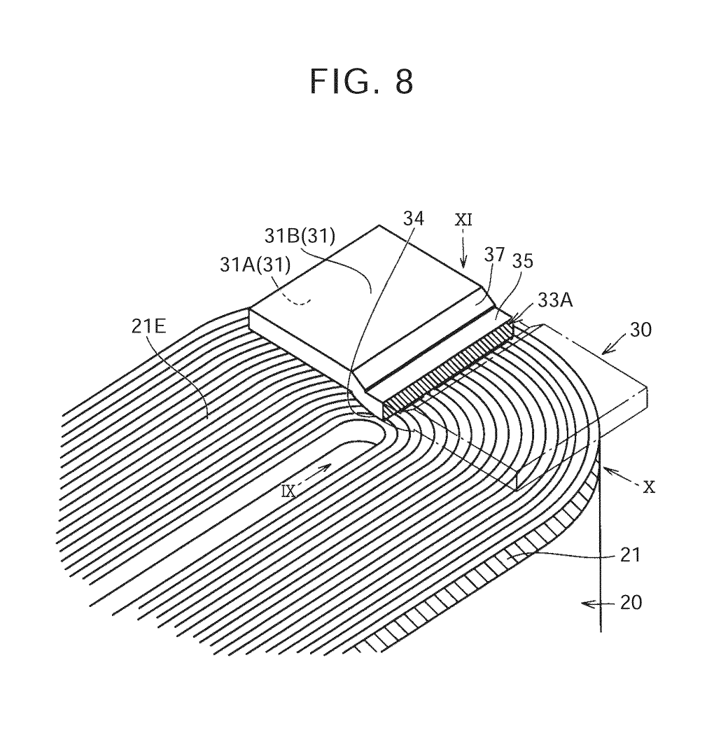

Referring now to FIGS. 5 and 8, after the positive collector terminal 30 (the secondary-battery collector terminal) having the above configuration is prepared, a welding process is performed (step S4). In FIG. 8, only a configuration around the welding projection portion 33A of the positive collector terminal 30 is illustrated partially. As illustrated in FIG. 8, the welding projection portion 33A of the positive collector terminal 30 abuts with (is pressed against) the edge portion 21E of the positive-electrode-core exposed portion 21. At this time, the front surface 31A (the first region 34) on a side exhibiting a projecting shape in the welding projection portion 33A is pressed against the edge portion 21E.

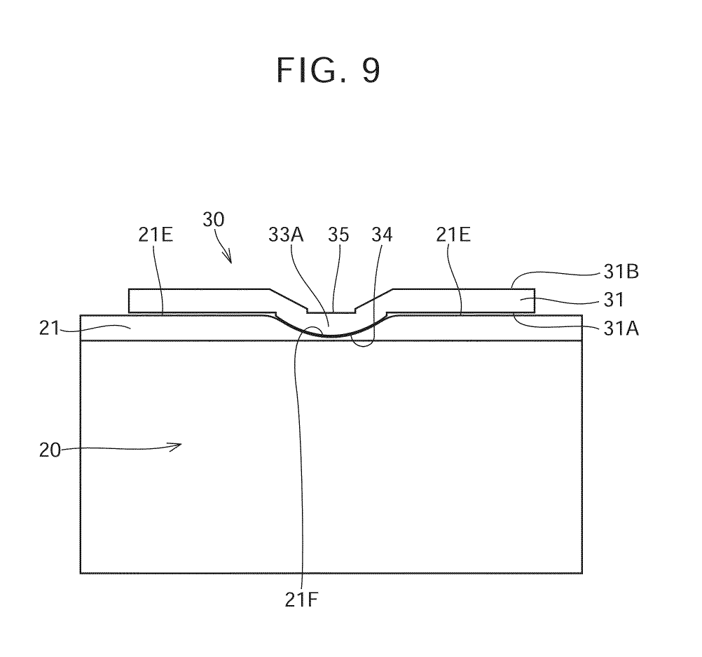

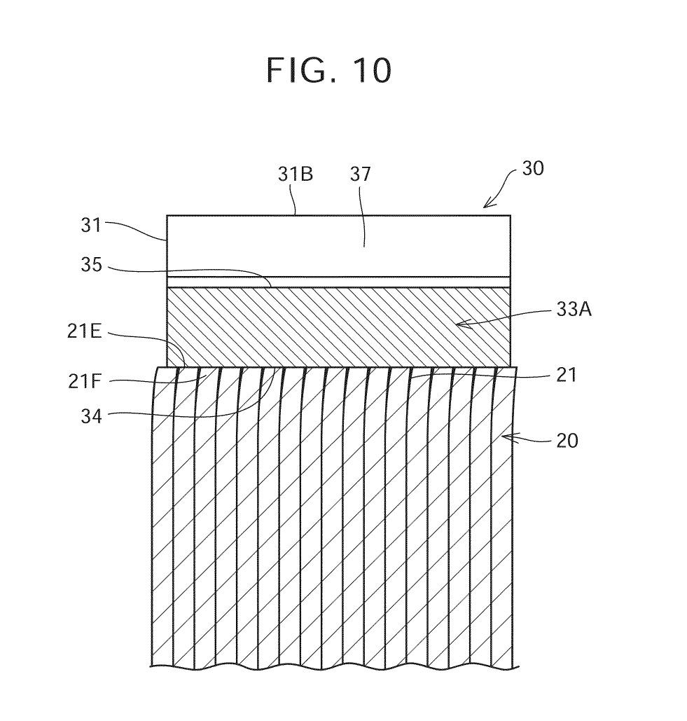

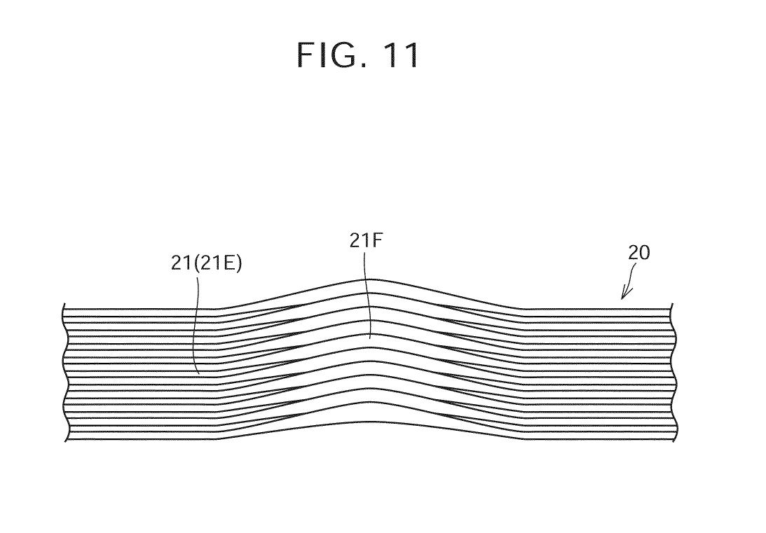

FIG. 9 is a view illustrating the positive collector terminal 30 and so on when viewed from a direction indicated by an arrow IX in FIG. 8. FIG. 10 is a view illustrating the positive collector terminal 30 and so on when viewed from a direction indicated by an arrow X in FIG. 8. FIG. 11 is a view illustrating the edge portion 21E of the positive-electrode-core exposed portion 21 when viewed from a direction indicated by an arrow XI in FIG. 8. When the front surface 31A (the first region 34) on a side exhibiting a projecting shape in the welding projection portion 33A is pressed against the edge portion 21E, a bent portion 21F is formed in the edge portion 21E of the positive-electrode-core exposed portion 21. In FIG. 11, the positive collector terminal 30 is not illustrated, so as to show a state of the bent portion 21F.

The bent portion 21F is a part formed by deforming the edge portion 21E of the positive-electrode-core exposed portion 21 so as to fall radially outwardly. Here, the electrode body 20 is manufactured such that a separator is provided between a positive electrode core and a negative electrode core and they are wound in a spiral shape. Accordingly, it is difficult to keep a uniform height of the edge portion 21E of the positive-electrode-core exposed portion 21 with accuracy, so that the edge portion 21E easily exhibits an uneven shape.

In the present embodiment, the front surface 31A (the first region 34) on a side exhibiting a projecting shape in the welding projection portion 33A is pressed against the edge portion 21E. As described above, the surface shape of the first region 34 is curved. The edge portion 21E of the positive-electrode-core exposed portion 21 starts making contact with the first region 34 from its tip end (the point Q4 in FIG. 7), so that the edge portion 21E can be deformed uniformly gradually along the surface shape (the curved shape) of the first region 34. Even if the edge portion 21E exhibits an uneven shape, local bending, buckling, or the like does not occur in the edge portion 21E so often (in comparison with a case where the sectional shape is a trapezoidal shape). The bent portion 21F thus uniformly deformed in a bending manner forms a generally flat surface to be subjected to welding (to be joined to the positive collector terminal 30) so that a stable contact state (a wide-range contact state) with the positive collector terminal 30 can be formed.

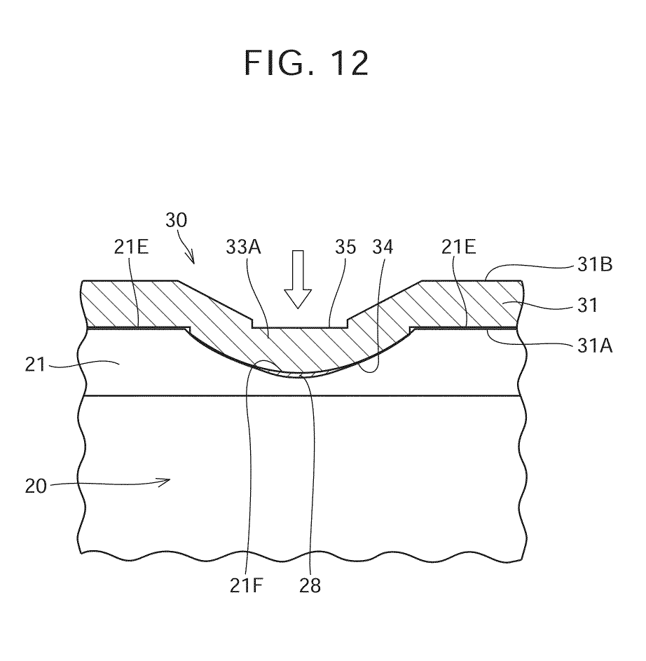

Referring now to FIG. 12, after the positive collector terminal 30 is placed at a predetermined position, a high energy beam such as laser is applied to the positive collector terminal 30 from a backside (a second-region-35 side) of the welding projection portion 33A. In the present embodiment, since a surface on the backside (the second-region-35 side) of the welding projection portion 33A is flat, it is possible to increase a tolerance limit of misalignment of the high energy beam such as laser to an irradiation position.

Since the surface on the backside (the second-region-35 side) of the welding projection portion 33A is flat, heat easily dissipates at the time when the high energy beam such as laser is applied toward the projection portion (in comparison with a case where a configuration with a simple semicircular shape is employed). It is also possible to restrain a temperature of the tip end of the welding projection portion 33A from increasing to a necessary temperature or more, and also to restrain the laser beam from penetrating through the welding projection portion 33A. It is also possible to restrain a short circuit between the positive electrode core and the negative electrode core due to melting of the separator, thereby making it possible to achieve improvement in yield.

A part of the positive collector terminal 30 (the welding projection portion 33A) and a part of the edge portion 21E of the positive-electrode-core exposed portion 21 are welded to each other upon receipt of energy, thereby forming a welded portion 28. Due to the formation of the welded portion 28, the positive collector terminal 30 can be firmly fixed to the edge portion 21E of the electrode body 20.

Again referring to FIG. 5, after the welding is completed, the electrode body 20 is inserted into the receptacle portion 11 (FIG. 1) (step S5). At this time, the positive collector terminal 30 and the negative collector terminal 40 are attached to the sealing plate 12 (FIG. 1) in advance, and then, the electrode body 20, the positive collector terminal 30, and the negative collector terminal 40 are inserted into the receptacle portion 11 in an integrated manner. After that, the sealing plate 12 is fixed to an opening of the receptacle portion 11 by laser welding, and a nonaqueous electrolyte is poured into the outer packaging can 10 from a hole (not shown) provided in the sealing plate 12 (step S6). The electrode body 20 is impregnated with the electrolyte. After that, the injection hole is closed, so as to seal the outer packaging can 10 (step S7). Thus, the secondary battery 100 is manufactured.

### (Operations and Effects)

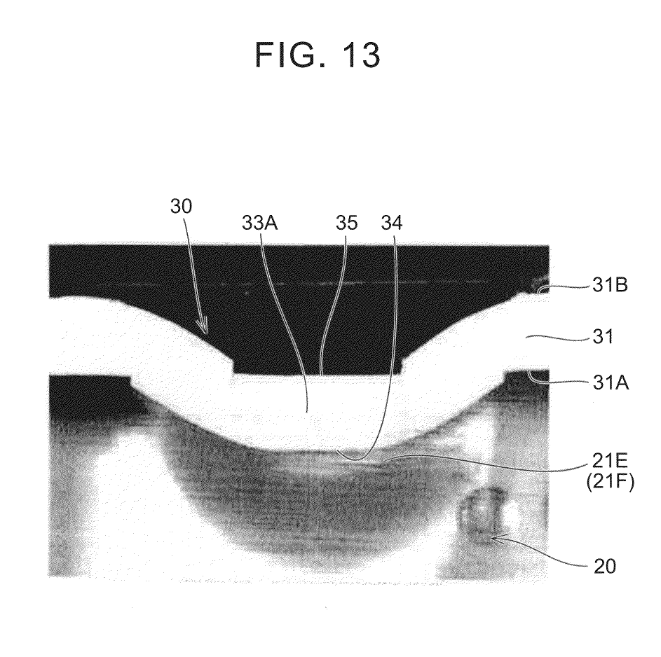

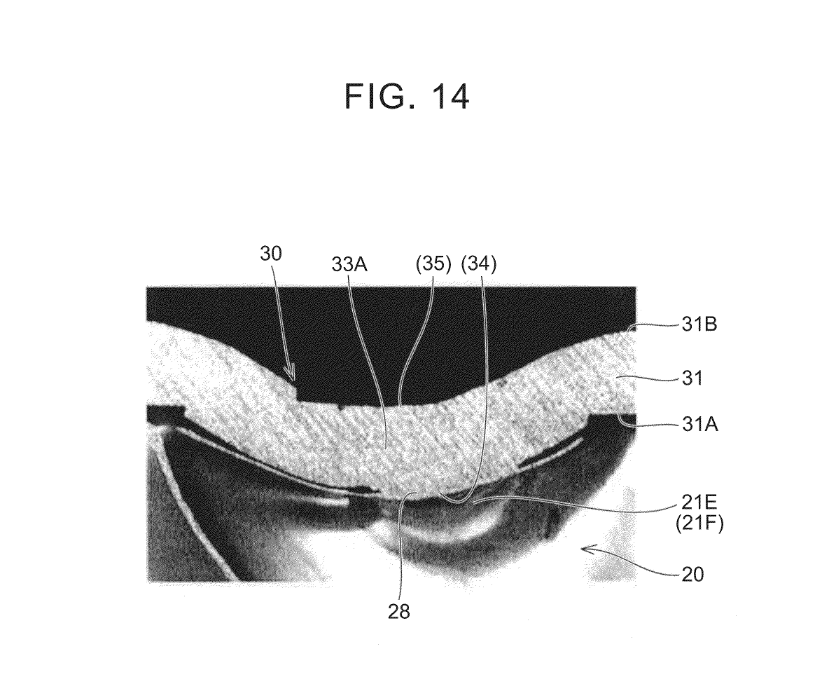

FIG. 13 is a picture illustrating a state before the welding projection portion 33A of the positive collector terminal 30 is welded to the edge portion 21E (the bent portion 21F) of the electrode body 20. FIG. 14 is a picture illustrating a state after the welding projection portion 33A of the positive collector terminal 30 is welded to the edge portion 21E (the bent portion 21F) of the electrode body 20.

Referring now to FIGS. 13 and 14, in a state before the positive collector terminal 30 is welded, the first region 34 has a curved shape and the second region 35 has a flat shape, as described above. At the time when the welding projection portion 33A of the positive collector terminal 30 is pressed against the edge portion 21E of the positive-electrode-core exposed portion 21, the edge portion 21E of the positive-electrode-core exposed portion 21 starts making contact with the first region 34 from its tip end (the point Q4 in FIG. 7), so that the edge portion 21E can be deformed uniformly along the surface shape (the curved shape) of the first region 34. The bent portion 21F thus uniformly deformed in a bending manner forms a generally flat surface to be subjected to welding (to be joined to the positive collector terminal 30). The edge portion 21E (the bent portion 21F) can make contact with the welding projection portion 33A in a large range in the direction (a right-left direction on a plane of paper of FIG. 13) perpendicular to the extending direction of the welding projection portion 33A (see FIG. 13).

As described above, in the present embodiment, since the surface on the backside (the second-region-35 side) of the welding projection portion 33A is flat, it is possible to increase a tolerance limit of misalignment of the high energy beam such as laser to an irradiation position. Since the surface on the backside (the second-region-35 side) of the welding projection portion 33A is flat, variations in an application height of the laser at the time when the laser is scanned (that is, an energy received by the welding projection portion 33A) can be restrained. Further, the positive-electrode-core exposed portion 21 (the bent portion 21F) forms a stable contact state with the positive collector terminal 30 (particularly, a state where the positive-electrode-core exposed portion 21 makes contact with the positive collector terminal 30 in a wide range in the direction perpendicular to the extending direction of the welding projection portion 33A). On this account, even if the irradiation position is misaligned, reliable welding can be realized.

Since the surface on the backside (the second-region-35 side) of the welding projection portion 33A is flat, heat easily dissipates at the time when the high energy beam such as laser is applied toward the projection portion (in comparison with a case where a configuration with a simple semicircular shape is employed). It is possible to restrain a temperature of the tip end of the welding projection portion 33A from increasing to a necessary temperature or more, and also to restrain the laser beam from penetrating through the welding projection portion 33A. It is also possible to restrain a short circuit between the positive electrode core and the negative electrode core due to melting of the separator, thereby making it possible to achieve improvement in yield. Accordingly, the positive collector terminal 30 can be joined to the edge portion 21E of the electrode body 20 with sufficient joining strength in comparison with a conventional technique (see FIG. 14).

### Other Exemplary Configurations

A shape of the electrode body 20 (see FIG. 1) may be flat or may be cylindrical. The electrode body 20 is not limited to a winding type, and may be a laminated type.

Referring now to FIG. 8, at the time when the welding projection portion 33A of the positive collector terminal 30 is pressed against the edge portion 21E of the positive-electrode-core exposed portion 21, the positive collector terminal 30 may be placed so that the edge portion 21E of the positive-electrode-core exposed portion 21 generally perpendicularly intersects with a direction (see FIG. 6) where the welding projection portion 33A extends linearly. In other words, the positive collector terminal 30 may be placed so that an electrode-plate laminating direction is parallel to a longitudinal direction (an extending direction) of the welding projection portion 33A. The electrode-plate laminating direction used herein is not only a concept applied only to the electrode body 20 of the laminating type, but also a concept applicable to the electrode body 20 of the winding type. If this configuration is employed, it is possible to achieve improvement in the joining strength.

Referring to FIG. 7, when the sectional shape of the welding projection portion 33A in the direction perpendicular to the extending direction thereof is viewed, a dimension of the welding projection portion 33A in a direction perpendicular to a thickness direction (an up-down direction on a plane of paper of FIG. 7) of the flat portion 31 is defined as “width.”

The second region 35 may have a width W1 of 0.5 mm or more. In other words, a linear distance between the point P4 and the point P5 may be 0.5 mm or more. The second region 35 preferably has a width W1 of 1.0 mm or more. If the width W1 is 0.5 mm or more, it is possible to easily perform positioning at the time when an energy beam for welding is applied. Even if the irradiation position is misaligned, there is little possibility that poor joining occurs.

The first region 34 may have a width W2 of 3 mm or less. In other words, a linear distance between the point Q3 and the point Q5 may be 3 mm or less. Here, a projection height from the flat portion 31 at the tip end (a position of the point Q4) of the welding projection portion 33A in a direction parallel to the thickness direction (the up-down direction on the plane of paper of FIG. 7) of the flat portion 31 is defined as a height H1. If the height H1 is a constant value at the time when the width W2 is increased, the width of the welding projection portion 33A is increased, but a curvature of the first region 34 is decreased. On this account, in a case where the width of the welding projection portion 33A is increased, the height of the welding projection portion 33A is also secured. In consideration of a range of the height H1, the first region 34 preferably has a width W2 of 2.5 mm or less.

The height H1, which is a projection height from the flat portion 31 at the tip end (the position of the point Q4) of the welding projection portion 33A, may be 0.5 mm or more. In other words, a distance between the point Q6 and the point Q4 in the up-down direction on the plane of paper of FIG. 7 may be 0.5 mm or more. If the height H1 is 0.5 mm or more, the welding projection portion 33A can make contact with the edge portion 21E of the positive-electrode-core exposed portion 21 sufficiently. The height H1 is preferably 1.0 mm or less. By setting a value of the height H1 appropriately, even if the edge portion 21E of the positive-electrode-core exposed portion 21 is deformed due to the positive collector terminal 30 (the welding projection portion 33A) being pressed against the edge portion 21E, it is possible to prevent unnecessary influence on a mixture layer and an adjacent collector terminal.

### Comparative Example 1

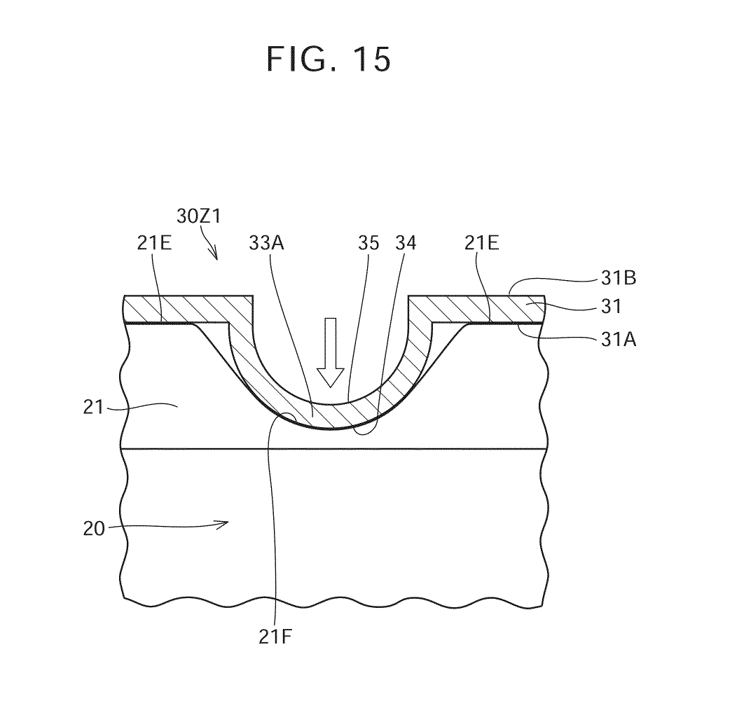

FIG. 15 is a sectional view illustrating a state where a positive collector terminal 30Z1 in Comparative Example 1 is welded to an edge portion 21E of an electrode body 20 (a positive-electrode-core exposed portion 21). In a state before welding, a sectional shape of a welding projection portion 33A of the positive collector terminal 30Z1 is a simple semicircular shape. That is, both a first region 34 and a second region 35 have curved surfaces.

In a case of Comparative Example 1, since a backside surface of the welding projection portion 33A (that surface of the welding projection portion 33A which exhibits a recessed shape) is curved, heat is hard to dissipate at the time when a high energy beam such as laser is applied toward the second region 35 of the welding projection portion 33A, and a temperature of a tip end of the welding projection portion 33A is easily increased to a necessary temperature or more. When the laser beam penetrates through the positive collector terminal 30Z1 (the welding projection portion 33A) due to the increase in the temperature, a separator melts, which may presumably cause a short circuit (a yield loss) between a positive electrode core and a negative electrode core.

### Comparative Example 2

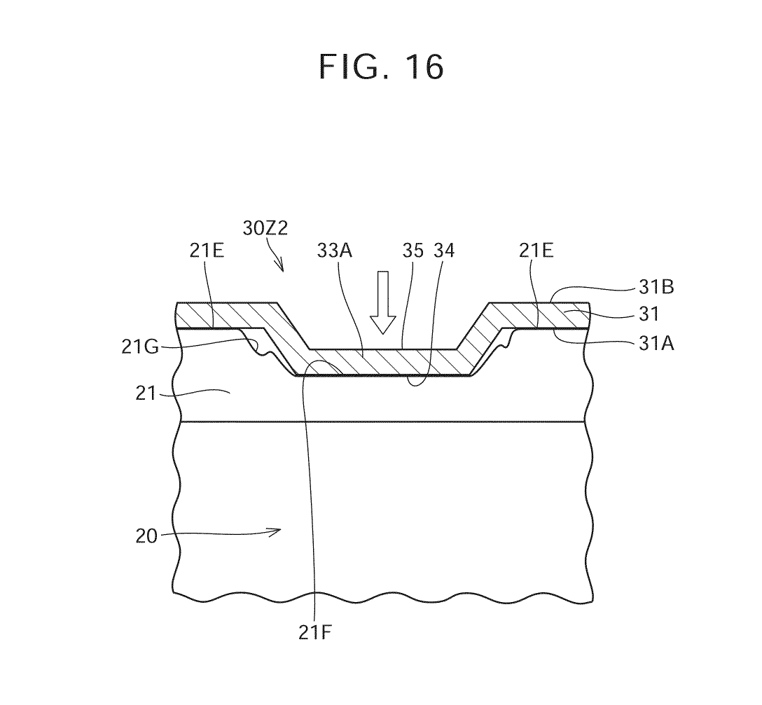

FIG. 16 is a sectional view illustrating a state where a positive collector terminal 30Z2 in Comparative Example 2 is welded to an edge portion 21E of an electrode body 20 (a positive-electrode-core exposed portion 21). In a state before welding, a sectional shape of a welding projection portion 33A of the positive collector terminal 30Z2 is a trapezoidal shape. That is, both a first region 34 and a second region 35 have flat surfaces.

In a case of Comparative Example 2, since that surface of the welding projection portion 33A which projects (that surface of the welding projection portion 33A which exhibits a projecting shape) is flat, at the time when the welding projection portion 33A is pressed against an edge portion 21E of the electrode body 20 (the positive-electrode-core exposed portion 21), the edge portion 21E of the electrode body 20 is hard to be bent uniformly. This may easily cause local bending 21G, buckling, or the like in the edge portion 21E of the electrode body 20. In a case where the local bending 21G or the like is caused in the edge portion 21E, it is difficult to join the collector terminal to the edge portion of the electrode body with sufficient welding strength.

### Comparative Example 3

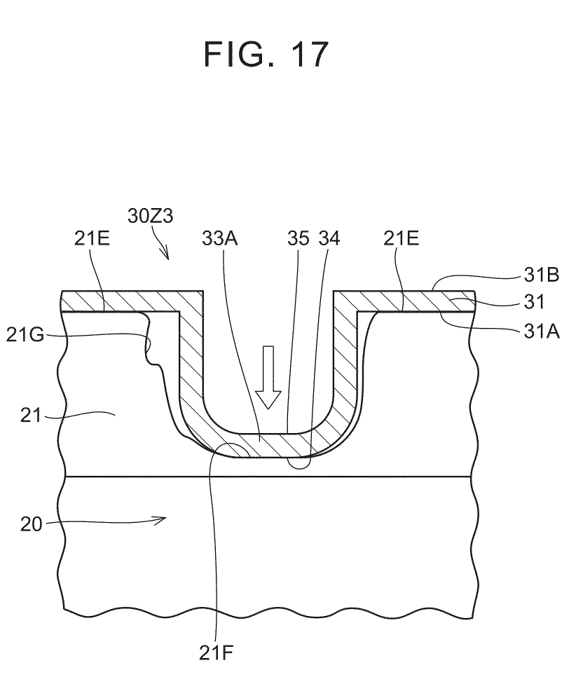

FIG. 17 is a sectional view illustrating a state where a positive collector terminal 30Z3 in Comparative Example 3 is welded to an edge portion 21E of an electrode body 20 (a positive-electrode-core exposed portion 21). In a state before welding, a sectional shape of a welding projection portion 33A of the positive collector terminal 30Z3 is a U-shape. That is, a first region 34 includes a flat surface and a curved surface, and a second region 35 also includes a flat surface and a curved surface. The welding projection portion 33A of the positive collector terminal 30Z3 does not employ such a configuration that “a surface shape of the first region 34 is curved and a surface shape of the second region 35 that is placed on a back-surface side of the first region 34 (a curved surface) in the welding projection portion 33A is flat.”

In other words, the welding projection portion 33A of the positive collector terminal 30Z3 does not have a part where the curved surface formed on a front-surface-31A side and the flat surface formed on a back-surface-31B side face each other. Such a part is not formed in the welding projection portion 33A, but a curved part formed on the front-surface-31A side faces a curved part formed on the back-surface-31B side, and a flat part formed on the front-surface-31A side faces a flat part formed on the back-surface-31B side.

In a case of Comparative Example 3, a part of that surface of the welding projection portion 33A which projects (that surface of the welding projection portion 33A which exhibits a projecting shape) is a flat surface, and both parts outside the flat surface have curved surfaces. According to this configuration, local bending 21G may be hard to be formed in comparison with a case of trapezoid (Comparative Example 2 illustrated in FIG. 16), but in comparison with Embodiment 1, it may be said that local bending 21G is easily formed.

Further, in a case of Comparative Example 3, a part of a backside surface of the welding projection portion 33A (that surface of the welding projection portion 33A which exhibits a recessed shape) is a flat surface, and both parts outside the flat surface have curved surfaces. According to this configuration, it is presumed that heat may easily dissipate at the time when a high energy beam such as laser is applied toward the second region 35 of the welding projection portion 33A, but it is considered that the same effect as Embodiment 1 cannot be expected.

### Modification

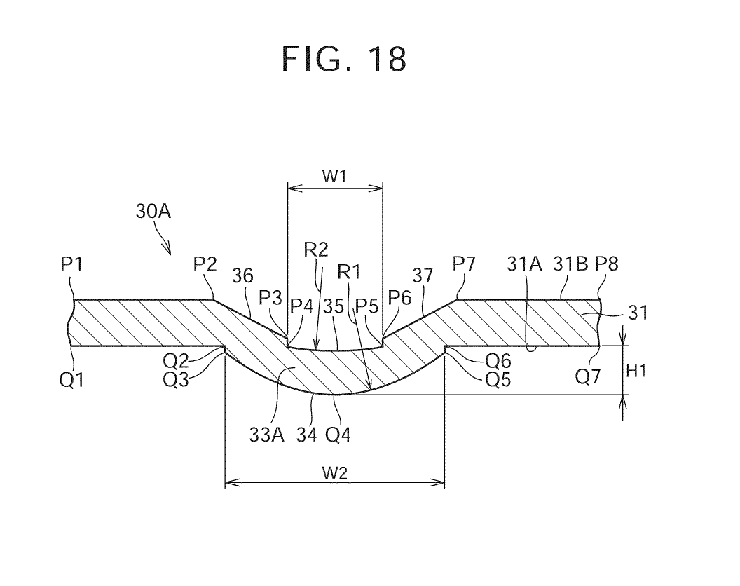

FIG. 18 is a sectional view illustrating a positive collector terminal 30A according to a modification of the positive collector terminal 30 (FIG. 7). In a case of the positive collector terminal 30 (FIG. 7), the second region 35 has a flat surface. In a case of a positive collector terminal 30A illustrated in FIG. 15, a second region 35 has a curved surface with a curvature radius R2 (a second curvature radius) larger than a curvature radius R1 (a first curvature radius) of a first region 34. A value of the curvature radius R2 is preferably as large as possible. An effect to be obtained by the positive collector terminal 30A is smaller than that of the positive collector terminal 30 in which the second region 35 has a flat surface, but in terms of the aforementioned viewpoint, the positive collector terminal 30A can provide an effect larger than Comparative Examples 1 to 3. It is preferable to optimize parameters of dimensions W1, W2, H1 so as to obtain a larger effect.

For example, the second region 35 may have a width W1 of 0.5 mm or more. The second region 35 preferably has a width W1 of 1.0 mm or more. The first region 34 may have a width W2 of 3 mm or less. The first region 34 preferably has a width W2 of 2.5 mm or less. A height H1, which is a projection height from the flat portion 31 at a tip end (a position of a point Q4) of a welding projection portion 33A, may be 0.5 mm or more. The height H1 is preferably 1.0 mm or less.

### EXAMPLES

In order to compare the effects of Embodiment 1 and Comparative Example 1, the following experiment was carried out. Initially, in order to manufacture an electrode body 20, a metal foil made of aluminum or aluminum alloy and having a thickness of 15 μm was prepared, and a positive-electrode active material was formed on either surface of the metal foil except an end part thereof, thereby forming a positive electrode core. Further, a metal foil made of copper and having a thickness of 10 μm was prepared, and a negative-electrode active material was formed on either surface of the metal foil except an end part thereof, thereby forming a negative electrode core.

The positive electrode core and the negative electrode core were cut into a predetermined dimension so that a battery capacity was 3.6 Ah. The positive electrode core and the negative electrode core thus formed in a belt shape were wound via a separator (a porous insulating layer). At this time, a positive-electrode-core exposed portion 21 of the positive electrode core was projected from one end of the separator, and a negative-electrode-core exposed portion 22 of the negative electrode core was projected from the other end of the separator. By the winding, an electrode body 20 having a flat shape was obtained. Such an electrode body 20 was prepared for Embodiment 1 and for Comparative Example 1 so as to have the same configuration.

Then, a positive collector terminal 30 and a negative collector terminal 40 were prepared for Embodiment 1. The positive collector terminal 30 was made of aluminum, and the negative collector terminal 40 was made of copper. The positive collector terminal 30 and the negative collector terminal 40 were both set to have a thickness to 0.6 mm, a width of 12 mm, and a length of 50 mm. A dimension W1 (a width W1 of a second region 35) illustrated in FIG. 7 was set to 1.3 mm, a dimension W2 (a width of a first region 34) was set to 2 mm, and a height H1 (a projection height from a flat portion 31 of a welding projection portion 33A) was set to 0.5 mm. The setting of these parameters was realized by press working. The positive collector terminal 30 and the negative collector terminal 40 having the above configuration were welded to an edge portion 21E of the electrode body 20 according to the procedure described in Embodiment 1, so as to obtain a secondary battery 100 (see FIG. 1). By the same technique, 30 secondary batteries 100 in total were obtained.

Further, a positive collector terminal 30Z1 (FIG. 15) and a negative collector terminal having the same configuration as this were prepared for Comparative Example 1. In Comparative Example 1, a dimension of a part corresponding to the dimension W2 (a width of a first region 34) illustrated in FIG. 7 was set to 1.0 mm, and a dimension of a part corresponding to the dimension H1 (a projection height from a flat portion 31 of a welding projection portion 33A) illustrated in FIG. 7 was set to 0.5 mm. The value of 0.5 mm was used to set the same height for the welding projection portion 33A in Comparative Example 1 and in Embodiment 1. The other configuration employed herein was the same in Comparative Example 1 and in Embodiment 1. Based on Comparative Example 1, 30 secondary batteries in total were obtained.

About each of the batteries thus obtained, charging and discharging performance at a high rate was observed, and then, the each of the batteries was disassembled so as to observe a welding state between the collector terminal and the edge portion 21E of the electrode body 20. About the charging and discharging performance, both Embodiment 1 and Comparative Example 1 exhibited a discharge characteristic greater than a predetermined threshold. However, when the batteries were disassembled to observe their welding states, poor joining was observed in 6 batteries out of 30 batteries as for Comparative Example 1. None of the batteries of Embodiment 1 had poor joining. Accordingly, based on the idea of Embodiment 1, it is found that a collector terminal can be joined to an edge portion of an electrode body with sufficient welding strength.

### Embodiments 2 to 10

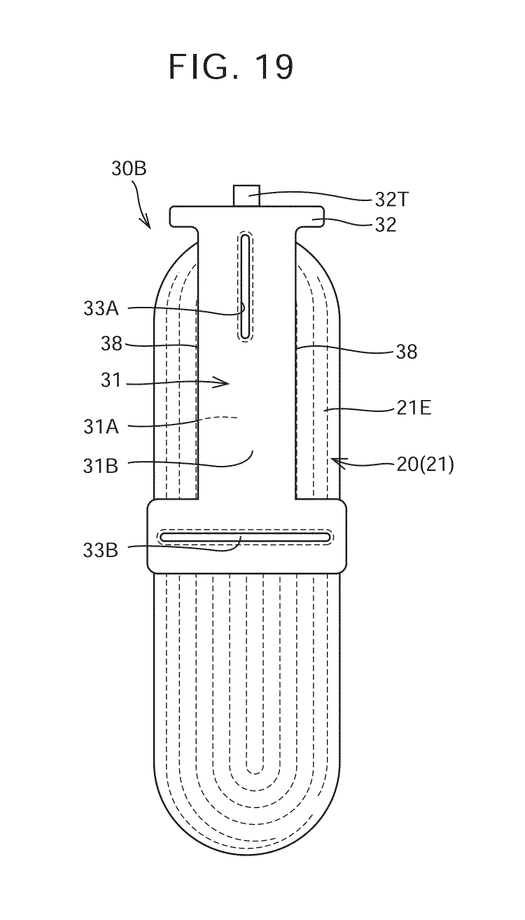

Referring now to FIGS. 19 to 27, the following describes collector terminals according to Embodiments 2 to 10. FIGS. 19 to 27 correspond to FIG. 6 in Embodiment 1. The following describes differences from Embodiment 1. In each of the following embodiments, at least one of a plurality of welding projection portions has the configuration described in detail in Embodiment 1 or its modification.

Referring now to FIG. 19, a positive collector terminal 30B in Embodiment 2 includes a flat portion 31 having a generally T-shape. The flat portion 31 is provided with two notch portions 38. A welding projection portion 33A is formed in that part of the flat portion 31 which is close to an extending portion 32. A welding projection portion 33B is formed in that part of the flat portion 31 which corresponds to a center of an edge portion 21E. The welding projection portions 33A, 33B are placed so that an electrode-plate laminating direction is parallel to respective longitudinal directions (extending directions) of the welding projection portions 33A, 33B. That is, the positive collector terminal 30B is placed so that an edge portion 21E (each edge portion) of a positive-electrode-core exposed portion generally perpendicularly intersects with respective directions where the welding projection portions 33A, 33B extend linearly. The positive collector terminal 30B is provided with the notch portions 38, and it may be said that the positive collector terminal 30B is excellent in an impregnation property of an electrolyte to the electrode body 20 and a discharge property of overcharge gas.

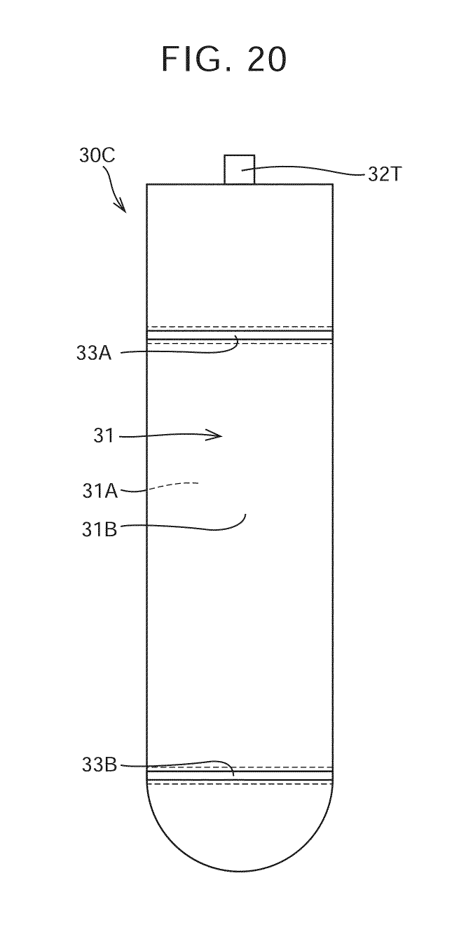

Referring now to FIG. 20, a positive collector terminal 30C in Embodiment 3 includes a flat portion 31 having a shape similar to that in Embodiment 1. Welding projection portions 33A, 33B extending in parallel to each other are formed in the flat portion 31. The welding projection portions 33A, 33B are placed so that an electrode-plate laminating direction is parallel to respective longitudinal directions (extending directions) of the welding projection portions 33A, 33B.

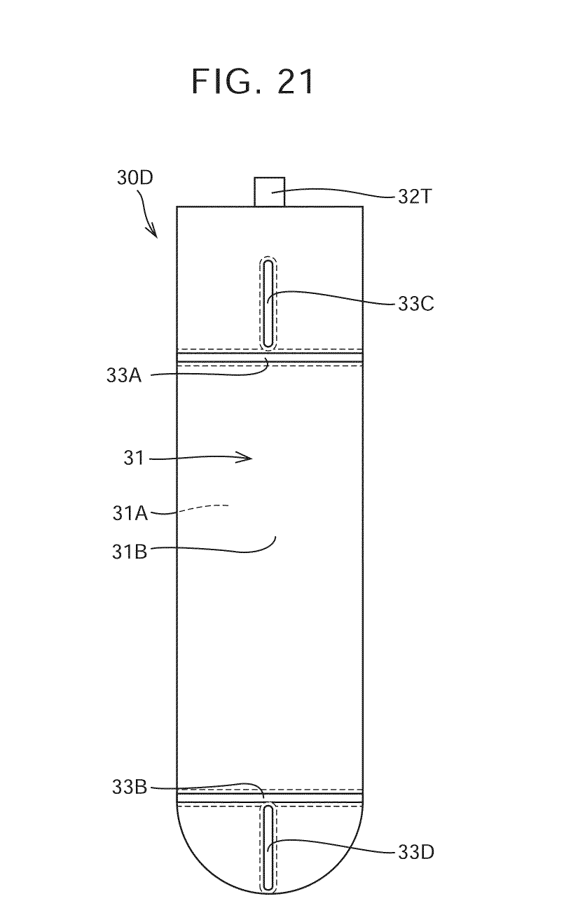

Referring now to FIG. 21, a positive collector terminal 30D in Embodiment 4 further includes welding projection portions 33C, 33D in addition to the configuration of the positive collector terminal 30C (FIG. 20) in Embodiment 3. The welding projection portions 33A, 33B, 33C, 33D are placed so that an electrode-plate laminating direction is parallel to respective longitudinal directions (extending directions) of the welding projection portions 33A, 33B, 33C, 33D.

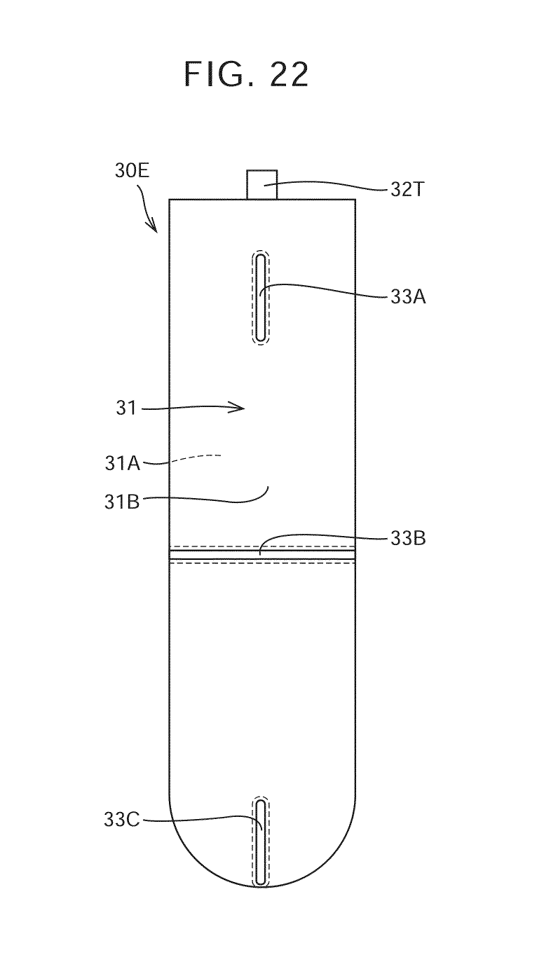

Referring now to FIG. 22, a positive collector terminal 30E in Embodiment 5 includes a welding projection portion 33B formed generally at a center of a flat portion 31, and welding projection portions 33A, 33C formed at positions where the welding projection portions 33A, 33C are linearly symmetrical with the welding projection portion 33B. The welding projection portions 33A, 33B, 33C are placed so that an electrode-plate laminating direction is parallel to respective longitudinal directions (extending directions) of the welding projection portions 33A, 33B, 33C.

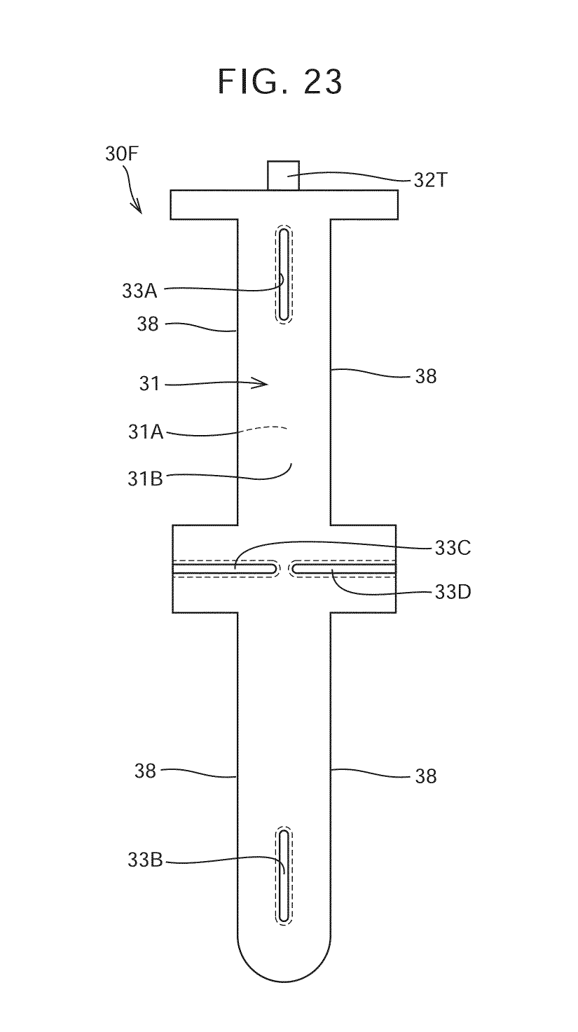

Referring now to FIG. 23, a positive collector terminal 30F in Embodiment 6 includes welding projection portions 33C, 33D formed generally at a center of a flat portion 31, and welding projection portions 33A, 33B formed at positions where the welding projection portions 33A, 33B are linearly symmetrical with the welding projection portions 33C, 33D. The flat portion 31 is provided with four notch portions 38. The welding projection portions 33A, 33B, 33C, 33D are placed so that an electrode-plate laminating direction is parallel to respective longitudinal directions (extending directions) of the welding projection portions 33A, 33B, 33C, 33D. The positive collector terminal 30F is provided with the notch portions 38, and it may be said that the positive collector terminal 30F is excellent in an impregnation property of an electrolyte to an electrode body 20 (not shown) and a discharge property of overcharge gas.

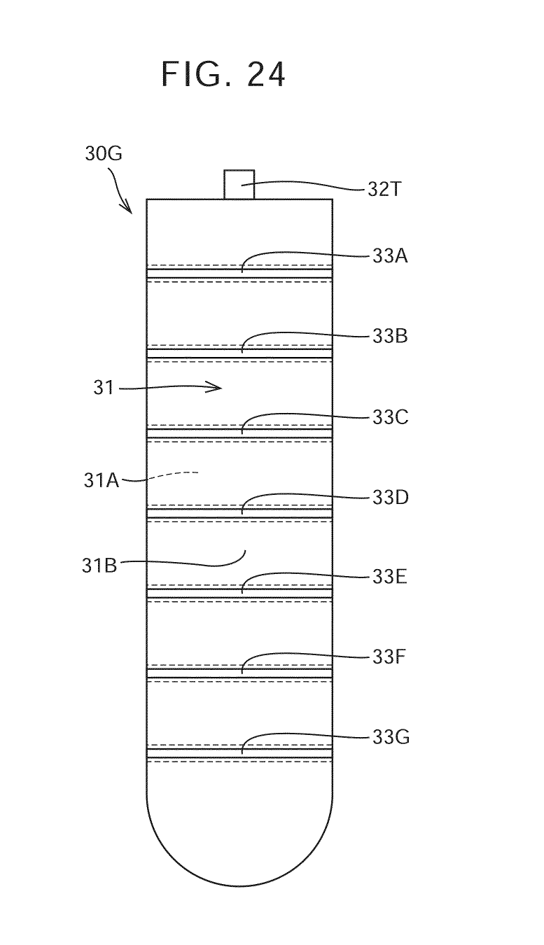

Referring now to FIG. 24, a positive collector terminal 30G in Embodiment 7 includes welding projection portions 33A to 33G provided in parallel to each other at regular intervals. The welding projection portions 33A to 33G are placed so that an electrode-plate laminating direction is parallel to respective longitudinal directions (extending directions) of the welding projection portions 33A to 33G.

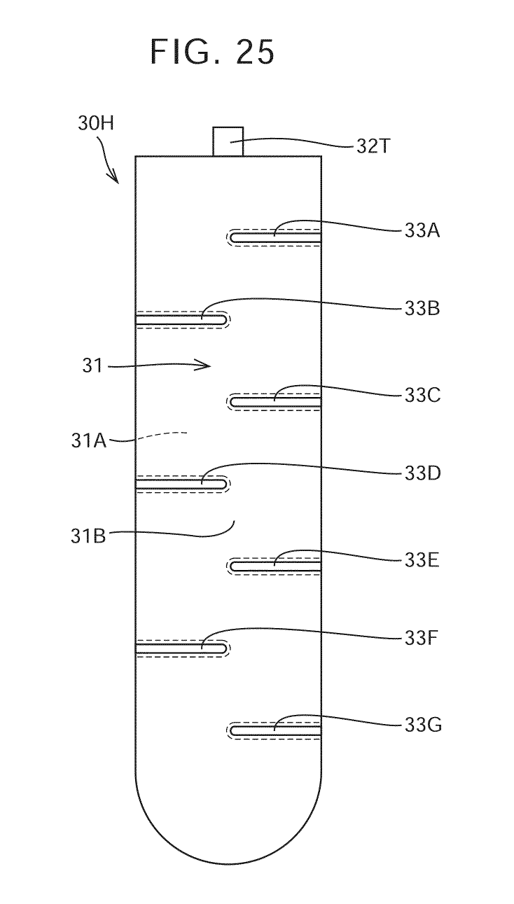

Referring now to FIG. 25, a positive collector terminal 30H in Embodiment 8 includes welding projection portions 33A, 33C, 33E, 33G provided in parallel to each other at regular intervals, and welding projection portions 33B, 33D, 33F provided in parallel to each other at regular intervals. The welding projection portions 33A to 33G are placed so that an electrode-plate laminating direction is parallel to respective longitudinal directions (extending directions) of the welding projection portions 33A to 33G.

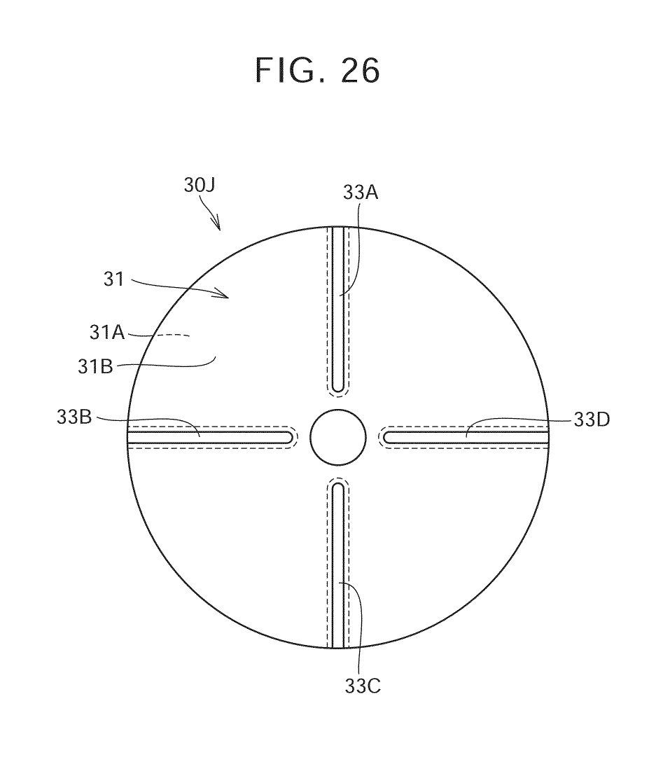

Referring now to FIG. 26, a positive collector terminal 30J in Embodiment 9 is applied to a so-called cylindrical electrode body, and welding projection portions 33A to 33D are provided in a flat portion 31 at an interval of 90° so that the welding projection portions 33A to 33D radially extend from a central part. The welding projection portions 33A to 33D are placed so that an electrode-plate laminating direction is parallel to respective longitudinal directions (extending directions) of the welding projection portions 33A to 33D.

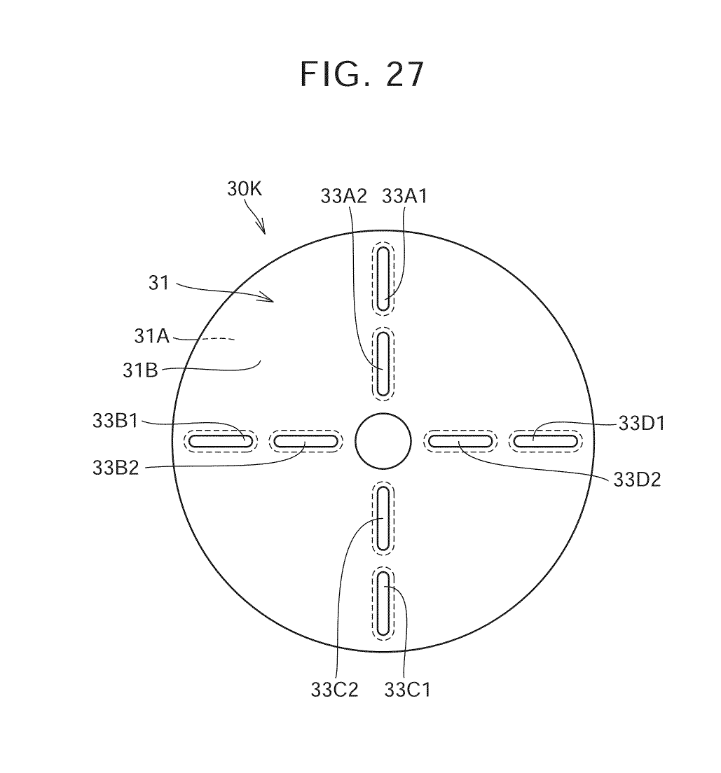

Referring now to FIG. 27, a positive collector terminal 30K in Embodiment 10 is also applied to a so-called cylindrical electrode body, and eight welding projection portions in total, that is, welding projection portions 33A1, 33A2, 33B1, 33B2, 33C1, 33C2, 33D1, 33D2 are provided in a flat portion 31 so as to radially extend from a central part. The welding projection portion 33A1, 33B1, 33C1, 33D1 are distanced from each other at an interval of 90°, and the welding projection portion 33A2, 33B2, 33C2, 33D2 are also distanced from each other at an interval of 90°. These welding projection portions are placed so that an electrode-plate laminating direction is parallel to respective longitudinal directions (extending directions) of these welding projection portions.

Embodiments, Comparative Examples, and Examples have been described as above, but contents described herein are just examples in all respects and are not limitative. A technical scope of the present invention is shown by Claims, and intended to include all modifications made within the meaning and scope equivalent to Claims.

What is claimed is:

1. A secondary-battery collector terminal to be welded to an edge portion of an electrode body, the secondary-battery collector terminal comprising:
a flat portion having a front surface and a back surface; and
a welding projection portion having a linearly extending shape, the welding projection portion being formed by projecting a part of the flat portion, wherein:
the welding projection portion has a shape projecting relative to the flat portion such that a front-surface side of the welding projection portion exhibits a projecting shape and a back-surface side of the welding projection portion exhibits a recessed shape; and
when a sectional shape of the welding projection portion in a direction perpendicular to an extending direction of the welding projection portion is viewed, a surface shape of that first region of the welding projection portion which is placed on the front-surface is curved, and a surface shape of that second region of the welding projection portion which is placed on a back-surface side relative to the first region is flat.

2. A secondary-battery collector terminal to be welded to an edge portion of an electrode body, the secondary-battery collector terminal comprising:
a flat portion having a front surface and a back surface; and
a welding projection portion having a linearly extending shape, the welding projection portion being formed by projecting a part of the flat portion, wherein
the welding projection portion has a shape projecting relative to the flat portion such that a front-surface side of the welding projection portion exhibits a projecting shape and a back-surface side of the welding projection portion exhibits a recessed shape; and
when a sectional shape of the welding projection portion in a direction perpendicular to an extending direction of the welding projection portion is viewed, a surface shape of that first region of the welding projection portion which is placed on the front-surface is curved with a first curvature radius, and a surface shape of that second region of the welding projection portion which is placed on a back-surface side relative to the first region is curved with a second curvature radius larger than the first curvature radius.

3. The secondary-battery collector terminal according to claim 1, wherein
in a case where a dimension in a direction perpendicular to a thickness direction of the flat portion is defined as a width when the sectional shape of the welding projection portion in the direction perpendicular to the extending direction of the welding projection portion is viewed, the first region has a width of 3 mm or less, the second region has a width of 0.5 mm or more, and in a direction parallel to the thickness direction of the flat portion, a projection height of a tip end of the welding projection portion from the flat portion is 0.5 mm or more.

4. A manufacturing method of a secondary battery, comprising:
preparing the secondary-battery collector terminal according to claim 1; and
applying laser for welding to the second region in a state where the first region of the secondary-battery collector terminal abuts with the edge portion of the electrode body.
